(19) United States
(12) Patent Application Publication
(10) Pub. No.: US 2010/0265032 A1
(43) Pub. Date: Oct. 21, 2010

(54) ENGINE STARTUP SYSTEM OF VEHICLE

(76) Inventor: Kaiji Nonaka, Miyagi-Ken (JP)

Correspondence Address: BRINKS HOFER GILSON & LIONE, P.O. BOX 10395, CHICAGO, IL, 60610, US

(21) Appl. No.: 12/762,740

(22) Filed: Apr. 19, 2010

(30) Foreign Application Priority Data
Apr. 20, 2009 (JP) 2009-101592

(51) Int. Cl. H04B 1/38

(52) U.S. Cl. 340/5.61

(57) ABSTRACT

An engine startup system of a vehicle permits engine startup under a condition of establishing authentication between an in-vehicle device mounted in the vehicle and a portable device carried by a user. The engine startup system includes: a transponder circuit installed in the portable device and activated upon receiving a query signal transmitted from the in-vehicle device to generate a primary reply signal for the authentication of the in-vehicle device; and a transmitting circuit installed together with the transponder circuit in the portable device and converting the primary reply signal generated by the transponder circuit into a transmission signal of another wavelength band to transmit the transmission signal as a secondary reply signal for the authentication of the in-vehicle device.

### CROSS REFERENCE TO RELATED APPLICATION

The present invention contains subject matter related to and claims priority to Japanese Patent Application JP 2009-101592 filed in the Japanese Patent Office on Apr. 20, 2009, the entire contents of which being incorporated herein by reference.

### BACKGROUND

1. Technical Field

The present disclosure relates to an engine startup system of a vehicle capable of permitting startup of an engine under the condition of establishing authentication between an in-vehicle device mounted in the vehicle and a portable device carried by a user by non-contact communication.

2. Related Art

This kind of system is called an immobilizer. In an immobilizer, a query signal for proximity communication is transmitted from a vehicle side when a mechanical key is inserted into an ignition switch (key cylinder), for example. When a transponder included in a key grip or the like replies to the query signal and generates a reply signal, a unique ID (identification) code of the key is extracted from the reply signal received from the vehicle side. Only when the unique ID code is identical with a pre-assigned ID code, the startup of an engine is permitted.

On the other hand, authentication by the ID code is also applied to a passive keyless entry device, for example. The keyless entry device automatically locks or unlocks a door when the ID code of an in-vehicle device mounted in a vehicle is identical with the ID code of a portable device carried by a user (driver).

In recent years, by applying an authentication method of the passive keyless entry device to the immobilizer, a keyless engine startup system has been realized, which permits startup of an engine without a mechanical key when a user carrying a regular portable device gets in a vehicle (when a portable device is in a vehicle). Such a system has an advantage in that the user getting in a vehicle no longer has to take out a key to insert the key into a key cylinder.

In particular, when the keyless entry authentication and the immobilizer authentication are installed together, the user can first get in a vehicle without using the key by the keyless entry authentication and also can start an engine without using the key by the immobilizer authentication even after getting in the vehicle. Therefore, it is very convenient for the user.

There is known a technique capable of carrying out restrictive communication (LF (Low Frequency) signal) within a relatively short distance by either an authentication function of the immobilizer or an authentication function of the passive keyless entry device and sharing an antenna or a communication circuit for both functions (for example, see Japanese Unexamined Patent Application Publication No. 2008-196228). According to this technique, since different antennas or communication devices for the immobilizer or the keyless entry device need not be provided in a vehicle, the number of constituent elements can be reduced.

When the elements for the passive keyless entry device are used together in the immobilizer, as in the above-mentioned technique, a door can be locked or unlocked without a key and an engine can also be started. Therefore, there is an advantage in terms of user convenience.

In order to realize the passive keyless entry device, however, several LF transmitting antennas have to be installed in several portions of a vehicle. Therefore, the equipment becomes larger on the whole and thus cost is increased.

When the equipment of the keyless entry device is omitted in order to reduce the cost by using only the function of the immobilizer, the authentication may not be performed using the LF antenna due to the fact that the LF antenna or the like is shared in the above-mentioned technique. In this case, since a transponder having a key has to be used for the authentication of the immobilizer (the keyless method cannot be used), a problem may arise in that the user is highly inconvenienced.

### SUMMARY

The engine startup system according to an embodiment includes a transmitting circuit and a transponder circuit. Therefore, when the transponder circuit is activated upon receiving a query signal transmitted from the in-vehicle device, the transponder circuit generates a reply signal for authentication. The reply signal contains a unique ID code of the portable device. Therefore, by verification with the ID code in the in-vehicle device, the authentication is established by non-contact communication.

The reply signal generated from the transponder circuit is transmitted as a primary reply signal from the portable device. However, the strength of the signal generated by the transponder circuit is normally lower in passive driving than in battery driving. Moreover, the range of access is limited to a very close distance (for example, 0.1 m or less). In this case, even though the user carries the portable device as normal, the authentication to the in-vehicle is not established and thus the engine startup is not permitted.

According to the embodiment of the invention, by converting a primary reply signal into another transmission signal and transmitting the converted transmission signal by the transmitting circuit, the ID code is configured to be transmitted from the transponder circuit to the in-vehicle device via the transmitting circuit. Since a secondary reply signal is a transmission signal with a wavelength band different from that of the primary reply signal and can be generated by the battery driving, the strength of the secondary reply signal is stronger than the primary reply signal. Moreover, the reach distance (for example, several m to several tens of m) of the secondary reply signal is longer.

With such a configuration, even when the user carries the portable device as normal, the reply result of the transponder circuit can reliably reach the in-vehicle device via the transmitting circuit. Therefore, the engine startup is permitted under the condition of establishing the authentication with the in-vehicle device.

In another embodiment, the in-vehicle device includes a transmitting/receiving circuit, a receiving circuit, and a control circuit. The transmitting/receiving circuit transmits the query signal to the portable device or receives the primary reply signal generated by the transponder circuit of the portable device. The receiving circuit receives the secondary reply signal transmitted from the transmitting circuit of the portable device. The control circuit has a function of performing the authentication on the basis of at least one of the primary reply signal received by the transmitting/receiving circuit and the secondary reply signal received by the receiving circuit.

### BRIEF DESCRIPTION OF THE DRAWINGS

FIG. 1 is a diagram illustrating the overall configuration of an engine startup system according to a first embodiment.

FIG. 2 is a block diagram schematically illustrating the control configuration of the engine startup system.

FIG. 3 is a flowchart illustrating a first control example of the engine startup system.

FIG. 4 is a diagram schematically illustrating a location relationship when a portable device is in a vehicle.

FIG. 5 is a flowchart illustrating a second control example of the engine startup system.

FIG. 6 is a block diagram schematically illustrating the control configuration of the engine startup system according to a second embodiment.

FIG. 7 is a diagram schematically illustrating the arrangement according to a suitable use example of the second embodiment.

### DESCRIPTION OF EXEMPLARY EMBODIMENTS

Hereinafter, preferred embodiments of the invention will be described with reference to the drawings.

### First Embodiment

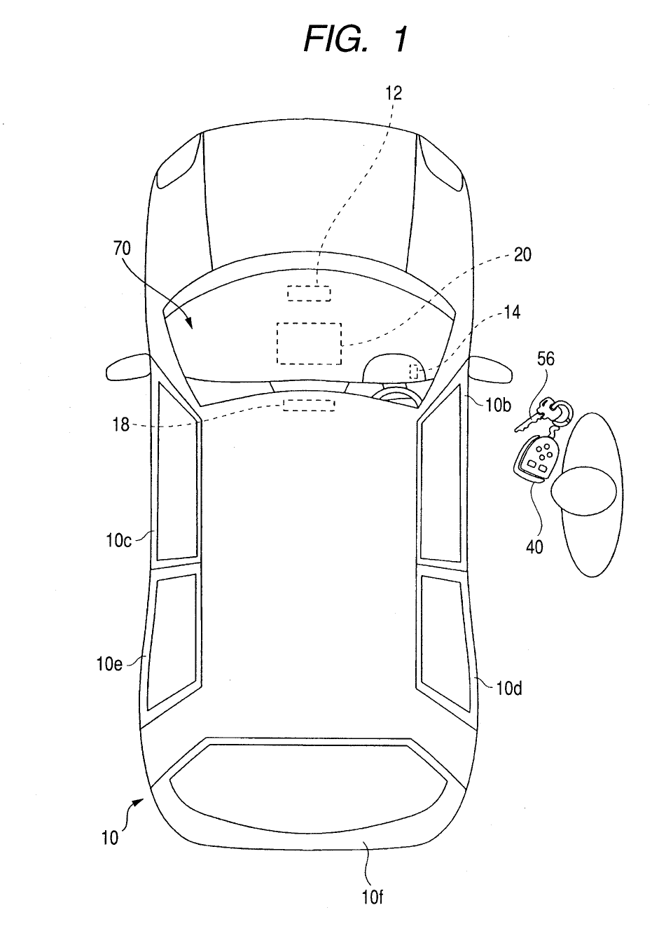

FIG. 1 is a diagram illustrating the overall configuration of an engine startup system according to a first embodiment. The engine startup system according to the first embodiment may be mounted in a vehicle 10 together with an active keyless entry device, for example. The active keyless entry device uses a portable device 40 carried by a user, for example, as a door locking/unlocking remote controller. Therefore, the user can lock or unlock a door by operating the portable device 40 without using a key 56 at a location distant from the vehicle 10.

In order to configure such an active keyless entry device, a receiving antenna 12 (RF receiving antenna) is installed in the vehicle 10. In this example, the receiving antenna 12 is installed in an instrument panel 70 of the vehicle 10, but may be installed in another unit. The portable device 40 has a transmitting circuit configured to transmit an active signal (RF signal) therein. For example, when the user operates (presses down) a push button (with no reference numeral) of the portable device 40, the portable device 40 transmits the RF signal of which an ID code is modulated.

The vehicle 10 is mounted with a coil antenna 14 to construct the engine startup system. In this example, the coil antenna 14 is installed around an ignition switch (key cylinder) (not shown), but may be installed in another unit.

According to the first embodiment, an LF antenna 18 is installed in the instrument panel 70, for example. The LF antenna 18 is a unit forming the engine startup system, like the coil antenna 14. This configuration will be described in more detail below.

A control module (BCM (Body Control Module)) 20 is installed inside the vehicle 10. The receiving antenna 12, the coil antenna 14, the LF antenna 18 are connected to the control module 20 through wirings (not shown). A communication circuit (not shown) of the vehicle is included in the control module 20. The communication circuit has a function of carrying out communication with the portable device 40 carried by the user. The configuration of the communication circuit will be described in detail below.

Since the keyless entry device is of an active type, no LF transmitting antenna is included in each portion (for example, right and left front doors 10b and 10c, right and left rear doors 10d and 10e, a back door 10f, or a roof) of the vehicle 10 as with the passive type.

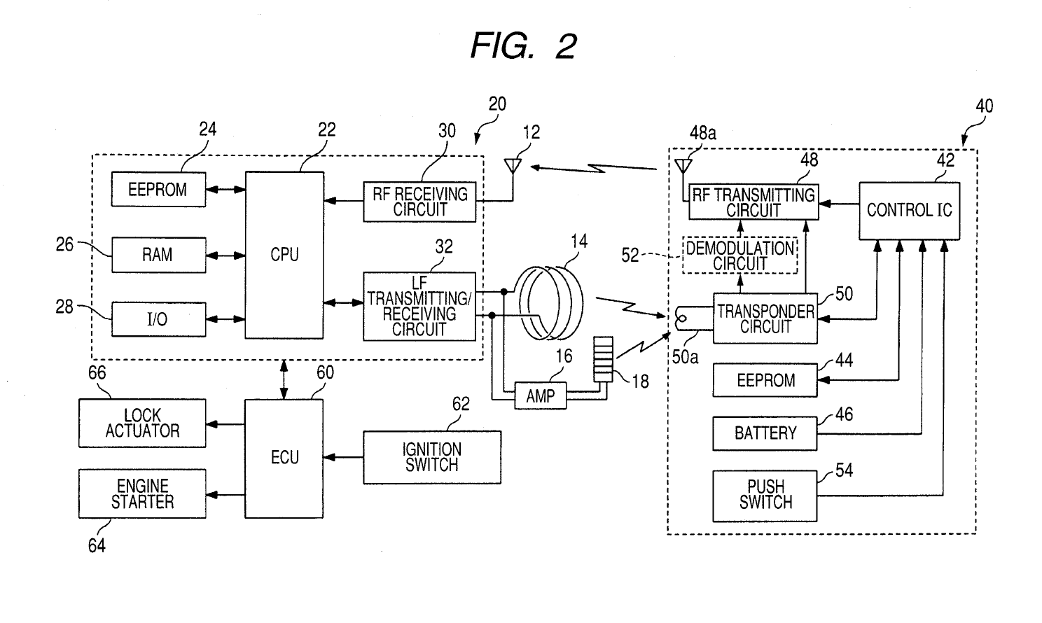

FIG. 2 is a block diagram schematically illustrating the configuration of the keyless entry device and the engine startup system. Hereinafter, each constituent element will be described.

### In-Vehicle Device

The control module 20 is configured as a computer including a CPU (Central Processing Unit) 22, memory devices such as an EEPROM (Electronically Erasable and Programmable Read-Only Memory) 24 and a RAM (Random Access Memory) 26, and a peripheral IC (Integrated Circuit) such as an input/output (I/O) driver 28. Control programs necessary for the operation of the keyless entry device and the engine startup system are written in an internal ROM (Read-Only Memory) (not shown) included in the CPU 22. The CPU 22 reads the control programs stored in the internal ROM and executes processes in accordance with the commands of the control programs. A pre-assigned unique ID code is written in the EEPROM 24. For example, the RAM 26 is a volatile memory usable as a main memory of the CPU 22. The input/output driver 28 inputs and outputs various signals between the control module 20 and another electronic device.

The control module 20 includes an RF receiving circuit 30 and an LF transmitting/receiving circuit 32 as communication circuits for the vehicle. Since the receiving antenna 12 is connected to the RF receiving circuit 30, the RF receiving circuit 30 receives the RF signal transmitted from the portable device 40 via the receiving antenna 12. The RF receiving circuit 30 demodulates the ID code contained in the received RF signal, for example, to supply the value (with a word length of 1 to 2 bytes, for example) of the demodulated ID code to the CPU 22.

According to the first embodiment, the LF antenna 18 is connected to the LF transmitting/receiving circuit 32 via an amplifier 16 together with the coil antenna 14. The LF transmitting/receiving circuit 32 operates in accordance with an instruction from the CPU 22 to transmit a query signal (LF signal) to the portable device 40 via the coil antenna 14. Since the LF antenna 18 is diverged from the coil antenna 14, the amplifier 16 amplifies the query signal (the LF signal) mainly transmitted from the coil antenna 14 and permits the LF antenna 18 to transmit the amplified query signal. In this way, even when the portable device 40 is away from the coil antenna 14 beyond the distance in which the coil antenna 14 is not able to easily output the query signal, the amplified query signal from the LF antenna 18 can reach the portable device 40.

The control module 20 is connected to another control unit 60 in the vehicle. The control unit 60 is configured as a microcomputer including a CPU, an EEPROM, a RAM, and an I/O unit (none of which is shown). The control unit 60 controls the operation of the vehicle 10 in cooperation with the control module 20. Therefore, for example, an ignition switch 62, an engine starter 64, and a lock actuator 66 of a door are connected to the control unit 60.

The ignition switch 62 is a switch that turns ON/OFF in synchronization with a key cylinder or an engine start button (not shown), for example. The engine starter 64 is, for example, a motor or a fuel injector (fuel injecting valve) performing cranking of an engine (not shown). When the control unit 60 receives an engine startup permitting signal from the control module 20, the control unit 60 activates the operation of the ignition switch 62. In this state, when the ignition switch 62 is operated, the control unit 60 performs control to activate the engine starter 64.

The lock actuator 66 is, for example, a motor or a solenoid that activates a locking or unlocking mechanism of the doors 10b to 10f. The control unit 60 activates the lock actuator 66 when a door handle or a lock pin (not shown) in the vehicle is operated. Moreover, the control unit 60 also performs control to activate the lock actuator 66 when receiving a keyless entry signal from the control module 20 of the keyless entry device.

For example, a keyless operation permitting signal at the time of an unlocking operation is output from the control module 20 to the control unit 60, when the RF signal is received from the portable device 40 and authentication is established with the control module 20 by using the ID code. Moreover, the keyless operation permitting signal at the time of a locking operation is output from the control module 20 to the control unit 60, when the RF signal is received from the portable device 40 and the authentication is established with the control module 20 by using the ID code, for example. Since the operation of the active keyless entry device is known, the description of the detailed control method is omitted.

### Portable Device

The portable device 40 is compact to be comfortably carried by the user. For example, a key holder type portable device connected to the key 56 may be used. The portable device 40 may be integrated with a grip portion of the key 56.

The portable device 40 includes a control IC 42, an EEPROM 44, a driving battery 46, an RF transmitting circuit 48, and a transponder circuit 50. The portable device 40 may include a demodulation circuit 52 (indicated by a dot line in the drawing), as necessary. A push switch 54 is attached to the portable device 40. A control program is embedded in a storage area of the control IC 42. Since a control program is embedded in a storage area of the control IC 42, the control IC 42 controls the operation (an RF transmitting operation of the RF transmitting circuit 48) of the portable device 40 in accordance with the command of the control program.

The portable device 40 includes a transmitting antenna (RF antenna) 48a and a coil antenna 50a. The transmitting antenna 48a is connected to the RF transmitting circuit 48 and the coil antenna 50a is connected to the transponder circuit 50. The RF transmitting circuit 48 has a configuration necessary for transmitting an active keyless entry signal (RF signal) when the push switch 54 is operated.

### Configuration of Keyless Entry System

For example, a plurality of the portable device 40 can be prepared for one vehicle 10. Therefore, each unique ID code can be assigned to each portable device 40. The unique ID code is written in advance in the EEPROM 44. Therefore, the ID code is configured so as to correspond to the ID code written in the EEPROM 24 of the vehicle. The control IC 42 modulates the ID code read from the EEPROM 44 and outputs the modulated signal to the RF transmitting circuit 48. Through the communication between the portable device 40 and the control module 20 of the vehicle, the CPU 22 of the control module 20 is able to perform the authentication of the portable device 40 by containing the ID codes in the signal. Therefore, the portable device 40 can be distinguished individually.

When the portable device 40 is used as the remote controller of the keyless entry device, the keyless entry signal (RF signal) containing a locking or unlocking ID code is output from the RF transmitting circuit 48 and is transmitted via the transmitting antenna 48a.

### Configuration of Engine Startup System

On the other hand, the transponder circuit 50 has a configuration (not shown) necessary for receiving the query signal via the coil antenna 50a, producing power by passive driving, and generating and transmitting a reply signal (LF signal). The transponder circuit 50 is configured as one chip IC, for example. Therefore, the unique ID code of the portable device 40 or the key 56 is stored in an internal memory of the transponder circuit 50. When receiving the query signal from the vehicle 10, the transponder circuit 50 is activated (generates power) to modulate the unique ID code, generate the reply signal, and transmit the reply signal via the coil antenna 50a.

### Generation of Primary Reply Signal

When the query signal is received from the vehicle 10 in a case where the portable device 40 is used as an immobilizer authentication key of the engine startup system, a replay signal is generated from the transponder circuit 50 and is transmitted as a primary replay signal via the coil antenna 50a.

### Conversion to Secondary Reply Signal and Transmission

According to the first embodiment, the replay signal from the transponder circuit 50 can be converted into the RF signal in the portable device 40 and the converted RF signal can be transmitted from the RF transmitting circuit 48. In the portable device 40, the replay signal (a signal of an LF wavelength band) generated in the transponder circuit 50 is supplied to the RF transmitting circuit 48. The RF transmitting circuit 48 modulates the received reply signal into the RF signal and converts the signal into a reply signal of an RF wavelength band to transmit the converted reply signal as the secondary reply signal via the transmitting antenna 48a.

In some cases, it is necessary to demodulate the replay signal depending on the transponder circuit 50. In this case, the demodulation circuit 52 (indicated by the dot line in the drawing) may once demodulate the reply signal (the signal of the LF wavelength band) generated in the transponder circuit 50 to supply the demodulated reply signal to the RF transmitting circuit 48.

The portable device 40 may include an LED (Light Emitting Diode) or the like for an operation monitor (not shown). For example, when the battery 46 is used up or the RF transmitting circuit 48 or the transponder circuit 50 performs the transmitting/receiving operation, the control IC 42 performs control to light the LED (not shown). The LED may be connected to the RF transmitting circuit 48 or the transponder circuit 50.

### Exemplary Control of Engine Startup System

Next, several examples of a method of controlling the operation of the engine startup system will be described according to the first embodiment.

### First Control Example

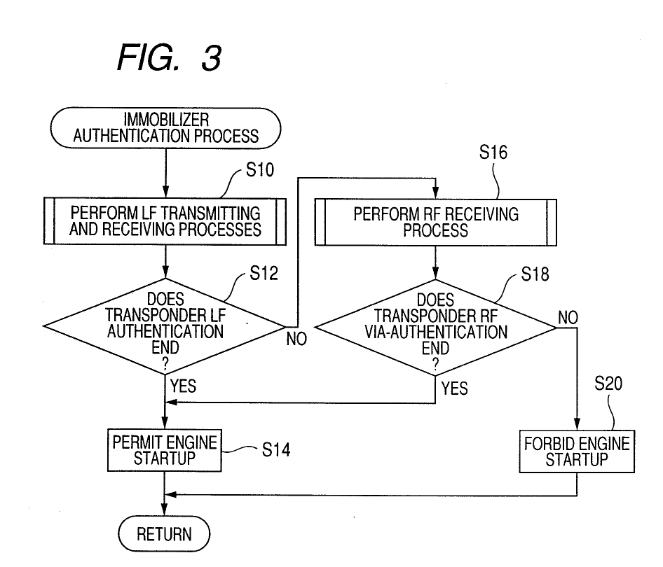

FIG. 3 is a flowchart illustrating a first control example of the engine startup system. The CPU 22 of the control module 20 calls an immobilizer authentication process from an internal ROM and executes the immobilizer authentication process shown in FIG. 3 as a timer interrupt process to control the operation of the engine startup system according to the first control example described below.

Step S10: When the control of the engine startup system is initiated, the CPU 22 first executes the LF transmitting and receiving processes. In these processes, the CPU 22 activates the LF transmitting/receiving circuit 32 of the control module 20 to transmit the query signal via the coil antenna 50a and also transmit the amplified query signal via the LF antenna 18.

When a certain transmission period (for example, tens of ms) expires, the CPU 22 switches the mode of the LF transmitting/receiving circuit 32 to a reception mode and then awaits the reply signal (the primary reply signal) from the portable device 40. At this time, when the LF transmitting/receiving circuit 32 receives the reply signal, the CPU 22 stores the demodulated value (the ID code for the immobilizer authentication) in the RAM 26.

When a certain reception period (for example, tens of ms) expires, the CPU 22 switches the mode of the LF transmitting/receiving circuit 32 into a transmission mode to transmit the query signal within the transmission period. When the transmission period expires, the CPU 22 switches the mode of the LF transmitting/receiving circuit 32 into the reception mode and awaits the reply signal within the reception period. Here, the transmission mode and the reception mode may be performed once or several times. Moreover, the transmission period and the reception period need not be equal to each other.

Step S12: When the LF transmission and receiving processes end, the CPU 22 subsequently confirms whether the authentication is established on the basis of the result of receiving the primary reply signal from the transponder circuit 50 by the LF transmitting/receiving circuit 32. The authentication is established when a condition (1) that the primary reply signal is received and a condition (2) that the ID code stored in the RAM 26 is identified with the ID code written in the EEPROM 24 are satisfied. When the two conditions are satisfied, the CPU 22 confirms that the authentication is established (Yes determination) and then executes step S14.

Step S14: In this step, the CPU 22 permits keyless engine startup. In this way, the engine startup permitting signal is transmitted from the control module 20 to the control unit 60.

Alternatively, when one of the conditions (1) and (2) in step S12 is satisfied and it cannot be confirmed that the authentication is established (No determination), the CPU 22 executes the next step S16.

In step S16, the CPU 22 executes the RF receiving process. In this process, the CPU 22 activates the RE receiving circuit 30 of the control module 20 to receive the secondary reply signal (the RF signal) transmitted from the portable device 40. When the RF receiving circuit 30 receives the reply signal, the CPU 22 stores the demodulated value (the ID code for the immobilizer authentication) in the RAM 26.

In step S18, when the RF receiving process ends, the CPU 22 confirms whether the authentication is established on the basis of the result of receiving the secondary reply signal via the RF receiving circuit 30. The authentication is established when a condition (1) that the secondary reply signal is received and a condition (2) that the ID code stored in the RAM 26 is identified with the ID code written in the EEPROM 24 are satisfied. When the two conditions are satisfied, the CPU 22 confirms that the authentication is established (Yes determination) and then executes step S14. In this case, likewise, the engine startup permitting signal is transmitted to the control unit 60.

Alternatively, when one of the conditions (1) and (2) in step S18 is not satisfied and thus it cannot be confirmed that the authentication is established (No determination), the CPU 22 executes the next step S20.

In step S20, the CPU 22 forbids (does not permit) the keyless engine startup. Therefore, since the engine startup permitting signal is not transmitted from the control module 20 to the control unit 60, the engine startup without using the key 56 is not permitted.

### Operation Example 1

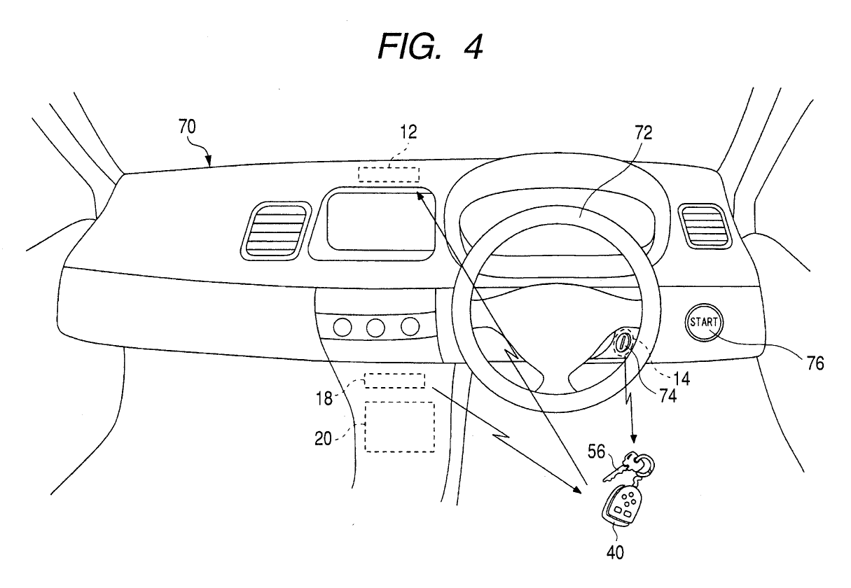

An exemplary operation (Operation Example 1) of executing the above-described first control example will be described. FIG. 4 is a diagram schematically illustrating a location relationship when the portable device 40 is in the vehicle 10.

For example, it is assumed that the user as a driver carrying the portable device 40 sits in a driver's seat. In this case, when the above-described immobilizer authentication process is performed, the query signal is first transmitted from the coil antenna 14 and the LF antenna 18 (step S10).

When the portable device 40 receives the query signal, the primary reply signal is generated in the internal transponder circuit 50, as described above. However, as in Operation Example 1, when the distance between the portable device 40 and the coil antenna 14 is large (for example, 0.1 m or more), the primary reply signal cannot reach the coil antenna 14. Therefore, in the control module 20 (the CPU 22), the authentication by the primary reply signal is not established (step S12: No).

In this embodiment, since the secondary reply signal converted into the RF signal is transmitted from the portable device 40, the secondary reply signal is received via the receiving antenna 12 (step S16) and thus the CPU 22 can confirm the establishment of the authentication (step S18: Yes).

### Example of Keyless Engine Startup

In the vehicle 10, an engine start button 76 is installed in the instrument panel 70. For example, the engine start button 76 is installed on the right side of a steering wheel 72.

When the user presses down the engine start button 76 in the state where the control module 20 (the CPU 22) confirms the establishment of the authentication, the control unit 60 performs the control to operate the engine starter 64 under two conditions, that is, condition (1) that the ignition switch 62 turns on and condition (2) that the engine startup permitting signal is received. Therefore, the engine (not shown) can be started without inserting the key 56 into the key cylinder 74.

When none of the conditions (1) and (2) is satisfied, the control unit 60 does not operate the engine starter 64. Alternatively, the control unit 60 may nullify the pressing of the engine start button 76.

### Second Control Example

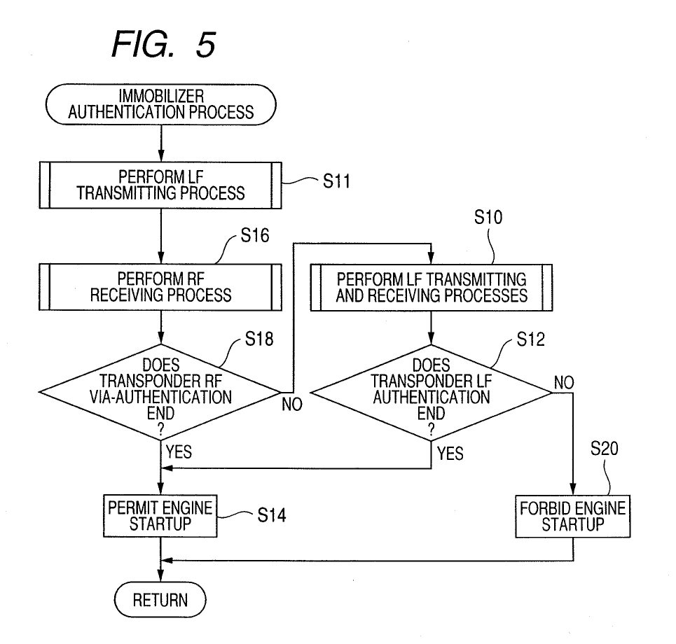

Next, FIG. 5 is a flowchart illustrating a second control example of the engine startup system. In the second control example, the sequence of steps S10 and S12 of the first control example shown in FIG. 3 and steps S16 and S18 may be changed and a LF transmitting process (step S11) may be added. The sequence of controlling the engine startup system according to the second control example will be described below.

In step S11, according to the second control example, the CPU 22 first performs the LF transmitting process. In this process, the CPU 22 activates the LF transmitting/receiving circuit 32 to transmit the query signal.

In step S16, the CPU 22 performs the RF receiving process before the reception (LF receiving process) of the primary reply signal. The details of this process have been described above.

In step S18, when the RF receiving process ends, the CPU 22 confirms whether the authentication is established on the basis of the result of receiving the secondary reply signal via the RF receiving circuit 30. When the establishment of the authentication is confirmed (Yes determination), the CPU 22 subsequently executes step S14. In this case, as described above, the engine startup permitting signal is transmitted to the control unit 60.

Alternatively, when the establishment of the authentication in step S18 cannot be confirmed (No determination), the CPU 22 first executes step S10.

In step S10, the CPU 22 executes the LF transmitting and receiving processes. The details of this process have been described above.

In step S12, when the LF transmitting and receiving processes end, the CPU 22 subsequently confirms whether the authentication is established on the basis of the result that the LF transmitting/receiving circuit 32 receives the primary reply signal. When the establishment of the authentication is confirmed (Yes determination), the CPU 22 subsequently executes step S14.

In step S14, the CPU 22 permits the keyless engine startup. In this way, the engine startup permitting signal is transmitted from the control module 20 to the control unit 60.

Alternatively, when the establishment of the authentication in step S12 cannot be confirmed (No determination), the CPU 22 subsequently executes step S20.

In step S20, the CPU 22 forbids (does not permit) the keyless engine startup. Therefore, since the engine startup permitting signal is not transmitted from the control module 20 to the control unit 60, the engine startup without using the key 56 is not permitted.

### Operation Example 2

An exemplary operation (Operation Example 2) of executing the above-described second control example will be described. As in FIG. 4, it is assumed that the user as a driver carrying the portable device 40 sits in a driver's seat. In this case, when the above-described immobilizer authentication process is performed, the query signal is first transmitted from the coil antenna 14 and the LF antenna 18 (step S11).

When the portable device 40 receives the query signal, the primary reply signal is generated in the internal transponder circuit 50, as described above. However, in Operation Example 2, the RF receiving circuit 30 receives the secondary reply signal (step S16) before the LF transmitting/receiving circuit 32 receives the primary reply signal.

When the authentication is established on the basis of the secondary reply signal in this step (step S18: Yes), the keyless engine startup is permitted.

Alternatively, when the authentication is not established on the basis of the second reply signal (step S18: No) but the authentication is established on the basis of the primary reply signal in the second control example (step S12: Yes), the engine startup is permitted. The establishment of the authentication on the basis of the secondary reply signal may not occur when the battery 46 of the portable device 40 is used up except when the ID code of the portable device 40 is not identified. That is, when the battery 46 is used up, the transmission output of the RF transmitting circuit 48 may decrease and thus the secondary reply signal may not reach the receiving antenna 12.

However, when the distance between the portable device 40 and the coil antenna 14 is large (for example, 0.1 m or more), the primary reply signal cannot reach the coil antenna 14, as in Operation Example 1. However, the establishment of the authentication on the basis of the primary reply signal can be confirmed, for example, by the user making the portable device 40 closer to the coil antenna 14 (for example, a distance of about several cm) (step S12: Yes). In this way, even when the battery 46 is used up, the keyless engine startup can be permitted.

In the above-described engine startup system according to the first embodiment, even when the units (several LF transmitting antennas) necessary for the passive keyless entry device are not provided in the vehicle 10, the keyless engine startup can be realized like the passive type. In this way, the configuration of the engine startup system can be simplified and thus the cost can be lowered.

The engine startup system according to the first embodiment can be realized by adding the transponder circuit 50 to the portable device 40 used as the existing active keyless entry device, for example, adding the demodulation circuit 52, as necessary, or rewriting a control program. Accordingly, the engine startup system can be supplied with little additional cost.

### Second Embodiment

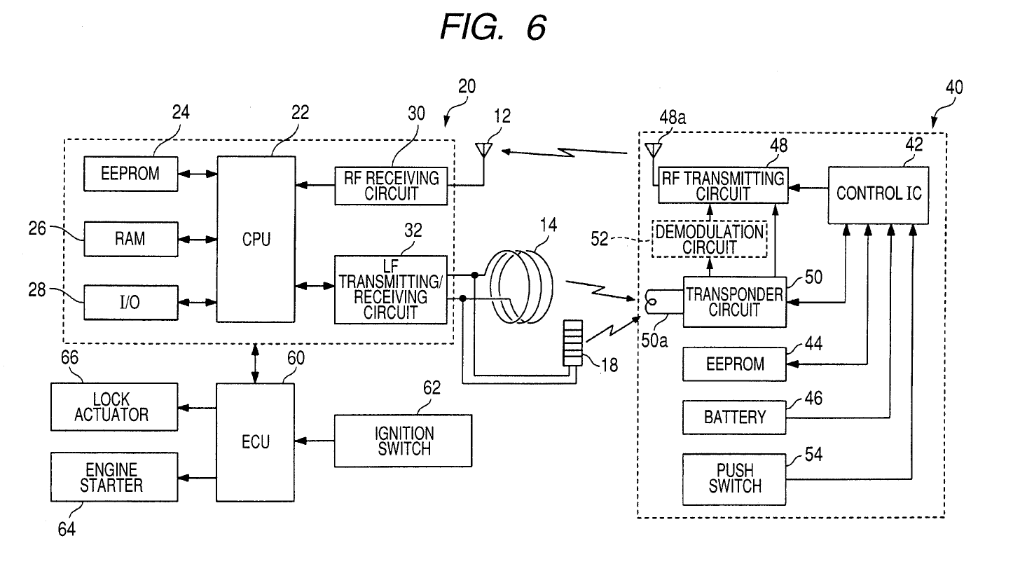

Next, an engine startup system according to a second embodiment will be described. FIG. 6 is a block diagram schematically illustrating the control configuration of the engine startup system according to the second embodiment.

In the engine startup system according to the second embodiment, the LF antenna 18 diverged from the coil antenna 14 is also installed in the vehicle. However, the amplifier 16 of the first embodiment is not installed. Even with such a configuration, the query signal can be transmitted from a plurality of places by installing the LF antenna 18 in the vehicle at the locations different from that of the coil antenna 14. The other configuration is the same as that of the first embodiment. The same reference numerals are given to the same constituent elements and the repeated description thereof is omitted.

### Use Example

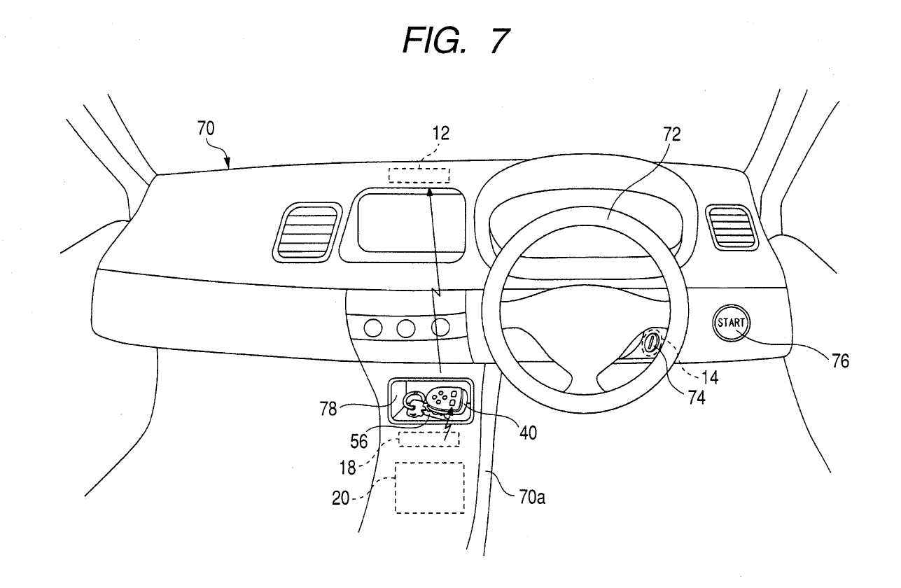

FIG. 7 is a diagram schematically illustrating the arrangement according to a suitable use example of the second embodiment. In the second embodiment, for example, the LF antenna 18 may be installed in a center console 70a incorporated with the instrument panel 70. A built-in key box 78 (console box) is installed in the center console 70a.

Since the key box 78 is open on the front surface of the center console 70a, the key box 78 has a depth toward the front side of the vehicle. The key box 78 has a size for accommodating the key 56 as well as the portable device 40 and a size enough for the user to take out the key 56 and the portable device 40.

In the second embodiment, the amplifier is not installed, but the LF antenna 18 can be installed in a location (for example, directly below, directly above, or on either side) of the key box 78. Therefore, in the state where the portable device 40 is accommodated in the key box 78, the query signal transmitted from the LF antenna 18 can reliably reach the portable device 40 (the coil antenna 50a).

An exemplary operation of this case will be performed as follows. That is, since the coil antenna 14 is greatly distant from the portable device 40, the portable device 40 normally receives the query signal from the LF antenna 18 installed in a nearby location. Subsequently, when the transponder circuit 50 generates the primary reply signal, the portable device 40 converts the primary reply signal into the RF signal and transmits the secondary reply signal. Then, when the receiving antenna 12 of the vehicle 10 receives the secondary reply signal, the CPU 22 of the control module 20 can confirm the establishment of the authentication.

Subsequently, as in the first embodiment, when the user presses down the engine start button 76, the control unit 60 performs the control to operate the engine starter 64 under two conditions, that is, the condition (1) that the ignition switch 62 turns on and the condition (2) that the engine startup permitting signal is received. Therefore, even when the portable device 40 and the key 56 are accommodated in the key box 78, the engine (not shown) can be started.

According to the second embodiment, since the amplifier need not be provided, the entire configuration can be further simplified. In this case, when the user takes out the portable device 40 and the key 56 from the user's pocket, the keyless engine startup is achieved. However, an advantage can be obtained in that the user can clearly set the place where the portable device 40 and the key 56 are put and the engine can be started when the user just puts them in the key box 78.

The LF antenna 18 may be installed in the key box 78 (in the accommodation space). The key box 78 may be disposed at a location other than the center console 70a. For example, the key box 78 may be disposed near the engine start button 76 and the LF antenna 18 may be installed near the key box 78.

In the above-described first and second embodiments, the LF antenna 18 has been installed in the vehicle 10. However, the LF antenna 18 need not be provided. In this case, when the LF antenna 18 is installed together with the amplifier 16, as in the first embodiment, the query signal can reliably reach the portable device 40 even in the case where this antenna and the amplifier are distanced from each other as in the passive type. Therefore, an advantage of improving the entire reply property can be obtained.

In the above-described first and second embodiments, the coil antenna 14 has been installed near the key cylinder 74. However, the coil antenna 14 may be installed near the engine start button 76, for example. The internal configuration of the portable device 40 may be included in the grip portion of the key 56, as described above.

It should be understood by those skilled in the art that various modifications, combinations, sub-combinations and alternations may occur depending on design requirements and other factors insofar as they are within the scope of the appended claims of the equipment thereof.

What is claimed is:

1. An engine startup system of a vehicle permitting engine startup under a condition that authentication between an in-vehicle device mounted in the vehicle and a portable device carried by a user is established, the engine startup system comprising:
a transponder circuit installed in the portable device and activated upon receiving a query signal transmitted from the in-vehicle device to generate a primary reply signal for the authentication of the in-vehicle device; and
a transmitting circuit, which is installed with the transponder circuit in the portable device, that converts the primary reply signal generated by the transponder circuit into a transmission signal of another wavelength band to transmit the transmission signal as a secondary reply signal for the authentication of the in-vehicle device.

2. The engine startup system of the vehicle according to claim 1, further comprising:
a transmitting/receiving circuit, which is installed in the in-vehicle device, that transmits the query signal to the portable device, and receives the primary reply signal generated by the transponder circuit of the portable device;
a receiving circuit, which is installed with the transmitting/receiving circuit in the in-vehicle device, that transmits the secondary reply signal transmitted from the transmitting circuit of the portable device; and
a control circuit that performs the authentication on the basis of at least one of the primary reply signal received by the transmitting/receiving circuit and the secondary reply signal received by the receiving circuit.

3. The engine startup system of the vehicle according to claim 2, further comprising:
a coil antenna, which is installed in the vehicle, that performs the transmission of the query signal and the reception of the primary reply signal by the transmitting/receiving circuit; and
an LF antenna diverged from the coil antenna to be installed in the vehicle that transmits the query signal from the transmitting/receiving circuit at a location different from that of the coil antenna.

4. The engine startup system of the vehicle according to claim 3, further comprising:
an amplifier that amplifies the query signal from the transmitting/receiving circuit to output the amplified query signal to the LF antenna.

5. The engine startup system of the vehicle according to claim 2, wherein when the control circuit performs the authentication on the basis of one of the primary reply signal and the secondary reply signal, the control circuit permits the engine startup without performing the authentication on the basis of the other thereof.

6. The engine startup system of the vehicle according to claim 5, wherein when the control circuit performs the authentication on the basis of the primary reply signal, the control circuit permits the engine startup without performing the authentication on the basis of the secondary reply signal.

7. The engine startup system of the vehicle according to claim 5, wherein when the control circuit performs the authentication on the basis of the secondary reply signal, the control circuit permits the engine startup without performing the authentication on the basis of the primary reply signal.

8. The engine startup system of the vehicle according to claim 2, wherein even when the control circuit is not able to perform the authentication on the basis of the primary reply signal, the control circuit permits the engine startup in a case where the authentication on the basis of the secondary reply signal can be performed.
